(19) United States
(12) Patent Application Publication
(10) Pub. No.: US 2012/0051965 A1
(43) Pub. Date: Mar. 1, 2012

(54) N-ACYLSARCOSINE COMPOSITIONS

(75) Inventors: Anil Choudhary, Mumbai (IN); Trivendra Kumar, Mumbai (IN)

(73) Assignee: BASF SE, LUDWIGSHAFEN (DE)

(21) Appl. No.: 13/146,949

(22) PCT Filed: Feb. 5, 2010
(86) PCT No.: PCT/EP2010/051450

§ 371 Date: Sep. 21, 2011

(30) Foreign Application Priority Data
Feb. 13, 2009 (EP) 09152757.2

(51) Int. Cl. C10M 129/28; C23F 11/12; C09K 5/00

(52) U.S. Cl. 422/7; 508/513; 252/79

(57) ABSTRACT

The invention relates to a composition for use as a metal working fluid, which comprises A) An additive mixture that essentially consists of a N-Acylsarcosine and a naphthenic acid or a salt thereof, polyalkylene or propylene glycol and further additives; and B) A functional fluid. The composition is useful in a process for protection against corrosion or oxidative degradation of zinc, aluminum or alloys thereof, or zinc-coated steels, wherein zinc, aluminum or alloys thereof are exposed to the composition.

The invention relates to an additive composition for use as a metal working fluid or corrosion protection oil and a process for the protection of metals, particularly zinc or aluminium alloys, against corrosion or oxidative degradation.

Additives, which have the purpose to protect metals against corrosion, are commonly grouped in two classes:

Metal deactivators are used to protect yellow metals or alloys, such as copper or brass, and display their protective action in functional liquids, such as mineral oil or fuels, by deactivating the metal ions contained therein. These metal ions can have catalytic effects in undesired oxidative decomposition processes of mineral oil or fuels. The protective action is explained by the formation of film-like layers on the surface of metals or by complex formation with metal ions.

Corrosion inhibitors are primarily used to protect ferrous metals, such as iron or steel. In close anlogy to metal deactivators corrosion inhibitors are also forming film-like layers on the surface of metals. In addition, some corrosion inhibitors can prevent the corrosion by emulsifying water and minimizing the direct contact of water with the metal surface.

Present metal protection methods focus primarily on iron and copper surfaces. However, other metals, such as zinc and aluminium and their related alloys, have become very important in many technical applications. Zinc and aluminium are, for example, widely used in the manufacture of automobiles. Zinc is used as corrosion protection coating of steels, e.g. zinc coated steel coils. Corrosion problems often occur during transport, handling and working of semi-finished metal products. Unfortunately, presently used metal deactivator compositions are less satisfactory or even unsatisfactory to protect these metal surfaces. Therefore, there is a clear need for improved metal working fluids to prevent corrosion of these metals.

Therefore, the invention relates to a composition, which comprises
A) An additive mixture that essentially consists of
   a) N-Acylsarcosine of the formula

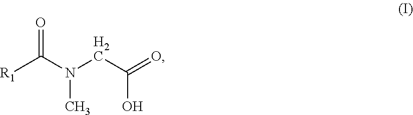

or a salt thereof,
Wherein
R₁ represents C₁-C₂₀alkyl or C₂-C₂₀alkenyl; and
b) A naphthenic acid of the formula

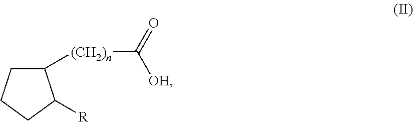

or a salt thereof,
Wherein n represents zero or a numeral from 1 to 10; and
R represents hydrogen or C₁-C₁₀ alkyl; and, as optional components,
c) Polyalkylene glycol or propylene glycol; and
d) Further additives; and
B) A functional fluid.

A preferred embodiment of the invention relates to a composition, which comprises
A) An additive mixture that essentially consists of
   a) The sodium salt of N-acylsarcosine (I), wherein R₁ represents C₂-C₂₀ alkenyl;
   b) The sodium salt of a naphthenic acid (II), wherein n represents zero and R represents hydrogen;
   c) Propylene glycol; and, optionally,
   d) Further additives; and
B) A functional fluid.

A particularly preferred embodiment of the invention relates to composition, which comprises
A) An additive mixture that essentially consists of
   a) The sodium salt of N-acylsarcosine (I), wherein R₁ represents oleoyl;
   b) The sodium salt of a naphthenic acid (II), wherein n represents zero and R represents hydrogen;
   c) Propylene glycol; and, optionally,
   d) Further additives; and
B) A functional fluid.

A highly preferred embodiment of the invention relates to composition, which comprises
A) An additive mixture that essentially consists of
   a) The sodium salt of N-acylsarcosine (I), wherein R₁ represents oleoyl;
   b) The sodium salt of a naphthenic acid (II), wherein n represents zero and R represents hydrogen;
   c) Propylene glycol; and, optionally,
   d) The sodium salt of oleic acid; and
B) A functional fluid.

The compositions as described above are suitable as corrosion inhibitor in non-aqueous, partially aqueous or aqueous functional fluids or liquids.

The expressions and terms used above and below are preferably defined as follows in the description of the present invention:

In a compound (I) R₁ defined as C₁-C₂₀alkyl includes saturated, unbranched or, where possible, branched hydrocarbon groups, especially C₁-C₉alkyl, e.g. methyl, ethyl, isopropyl, n-butyl, isobutyl, tert-butyl, n-pentyl, neopentyl, isopentyl, n-hexyl, 2-ethylbutyl, 1-methylpentyl, 1,3-dimethylbutyl, n-heptyl, 3-heptyl, 1-methylhexyl, isoheptyl, n-octyl, 2-ethylhexyl, 1,1,3,3-tetramethylbutyl, 1-methylheptyl, n-nonyl or 1,1,3-trimethylhexyl, and also C₁₀-C₂₀alkyl, especially straight-chain C₁₀-C₂₀alkyl, e.g. n-decyl, n-dodecyl, n-tetradecyl, n-hexadecyl or n-octadecyl or branched C₁₀-C₂₀alkyl, e.g. 1-methylundecyl, 2-n-butyl-n-octyl, isotridecyl, 2-n-hexyl-n-decyl or 2-n-octyl-n-dodecyl, or higher homologues thereof.

In a compound (I) R₁ defined as C₂-C₂₀alkenyl is a straight chain or, where possible, branched radical, for example vinyl, allyl, 2-butenyl, 3-butenyl, isobutenyl, n-2,4-pentadienyl, 3-methyl-2-butenyl, n-2-octenyl, n-2-dodecenyl or iso-dodecenyl.

According to a preferred embodiment, R₁ is defined as C₆-C₁₈alkenyl and is preferably a group as represented by the partial formula

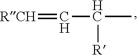

Wherein R′ and R″ are independently of one another hydrogen or substantially straight chain hydrocarbyl groups, with the proviso that the total number of carbon atoms in R is within the indicated ranges. Preferably R′ and R″ are C₃-C₁₅alkyl or C₃-C₁₅alkenyl groups. In a particularly advantageous embodiment, R has from about 16 to about 18 C-atoms, R′ is hydrogen or C₁-C₇alkyl or C₂-C₇alkenyl and R″ is C₅-C₁₅alkyl or C₅-C₁₅alkenyl.

N-acylsarcosine (I) is a known corrosion inhibitor for lubricating oils, greases and fuels, and commercially distributed as Ciba®Sarkosyl®O.

In a compound (II), n represents zero or a numeral from 1 to 10. According to a preferred embodiment, n represents zero.

In a compound (II), R defined as C₁-C₁₀alkyl, includes saturated, unbranched or, where possible, branched hydrocarbon groups, such as the C₁-C₄alkyl groups defined above.

Naphthenic acids (II) are known compounds and exist as natural products in crude oil fractions.

The term salts of compounds (I) and (II) comprises within its scope preferably a metal salt, for example an alkali metal or alkaline earth metal salt, e.g. the sodium, potassium, or the magnesium salt.

According to an alternative embodiment, the term salt comprises non-metallic salts, e.g. the acid addition salts obtainable by reaction of n-acylsarcosine (I) or naphthenic acids (II) with ammonia or amines, e.g. the (C₁-C₄alkyl)₄N⁺, (C₁-C₄alkyl)₃NH⁺, (C₂-C₄alkylOH)₄N⁺, (C₂-C₄alkylOH)₃NH⁺, (C₂-C₄alkylOH)₂N(CH₃)₂⁺, (C₂-C₄alkylOH)₂NHCH₃⁺, (C₆H₅)₄N⁺, (C₆H₅)₃NH⁺, (C₆H₅CH₃)₄N⁺, (C₆H₅CH₃)₃NH⁺or the NH₄⁺salt.

Polyalkylene glycol (polyalkylene oxides) or mixtures thereof are derived from polyethylene glycol or polypropylene glycol (=polyethylene oxide or polypropylene oxide) or mixed polymerisates thereof and are represented by the formula

HOCH₂—CHRₐ—OₙCH₂—CHR_{b}—OH (III),

wherein n is a numeral from 1 to about 1.0×10⁶ and Rₐ and R_{b} represent hydrogen or methyl. Suitable water soluble polyalkylene glycol (polyalkylene oxides) or mixtures thereof are used as heat transfer fluids in the plastics industry and in the reflowing of printed circuit boards at temperatures of 200° C. to 240° C. They show improved performance over petroleum oils or non-aqueous solutions of polyethylene glycols because of their good thermal and oxidative stability, good heat transfer characteristics, high flash points, low tendency to sludge formation, non staining behaviour or low pour point.

Particularly preferred are high viscosity polyalkylene glycols that meet the following specifications:
Viscosity range according to ASTM D445 at 40° C. between 10 000 and 200 000 (cSt) and at 100° C. between 1 000 and 180 000;
Pour point according to ASTM D97 between 0° C. and 20° C.;
Flash point (open cup) above 200° C.;
Cloud point between 50-80° C.

A further embodiment of the invention relates to the additive mixture of Component A), which comprises
a) N-Acylsarcosine (I) or a salt thereof,
Wherein
R₁ represents C₁₀-C₂₀alkyl or C₁₀-C₂₀alkenyl;
b) A naphthenic acid of the formula or a salt thereof,
Wherein n represents zero or a numeral from 1 to 10; and
R represents hydrogen or C₁-C₁₀alkyl; and, as optional component,
c) Propylene glycol.

A particularly preferred embodiment relates to an additive mixture of Component A), which comprises
a) The sodium salt of N-acylsarcosine (I), wherein R₁ represents oleoyl;
b) The sodium salt of a naphthenic acid (II), wherein n represents zero and R represents hydrogen;
c) Propylene glycol and
d) The sodium salt of oleic acid.

The ratio of component a) to component b) to component c) present in the additive mixture A) may vary within the ranges of approximately from 10:10:80 and 80:10:10 to 10:80:10% by weight.

The term functional liquid of Component B) includes non-aqueous, partially aqueous and aqueous liquids which are in contact with metals to be protected, in particular aluminium and zinc.

Examples of non-aqueous functional liquids are fuels, e.g. hydrocarbon mixtures comprising mineral oil fractions which are liquid at room temperature and are suitable for use in internal combustion engines, e.g. internal combustion engines with external (petrol engines) or internal ignition (diesel engines), e.g. petrol having different octane contents (regular grade or premium grade petrol) or diesel fuels, and lubricants, hydraulic fluids, metal working fluids, such as drawing oil, cutting oils, forming oils, drilling oils etc, engine coolants, transformer oils and switchgear oils.

Examples of suitable partially aqueous functional liquids are water-in-oil or oil-in-water metal working fluids, hydraulic fluids based on aqueous polyglycol/polyglycol ether mixtures or glycol systems, and engine cooling systems based on aqueous glycol.

Examples of aqueous functional liquids are industrial cooling water, filling compositions of a water conditioning plant, steam generation systems, sea water evaporation systems, sugar evaporation systems, irrigation systems, hydrostatic boilers and heating systems or cooling systems having a closed circulation.

Although the total content of the additive mixture A) in the composition is not critical, the preferred total content of the additive mixture A), the composition according to the invention preferably comprises 0.01 to 30.0% by weight, in particular 0.01 to 10.0%, preferably 0.02 to 3.0% by weight, of the additive mixture, as defined above, based on the weight of the functional liquid of Component B).

Non-aqueous functional liquids are preferred, in particular base oils of lubricating viscosity, which can be used for the preparation of greases, metal working fluids, gear fluids and hydraulic fluids.

Suitable greases, metal working fluids, gear fluids and hydraulic fluids are based, for example, on mineral or synthetic oils or mixtures thereof. The lubricants are familiar to a person skilled in the art and are described in the relevant literature, such as, for example, in Chemistry and Technology of Lubricants; Mortier, R. M. and Orszulik, S. T. (Editors); 1992 Blackie and Son Ltd. for GB, VCH-Publishers N.Y. for U.S., ISBN 0-216-92921-0, cf. pages 208 et seq. and 269 et seq.; in Kirk-Othmer Encyclopedia of Chemical Technology, Fourth Edition 1969, J. Wiley & Sons, New York, Vol. 13, page 533 et seq. (Hydraulic Fluids); Performance Testing of Hydraulic Fluids; R. Tourret and E. P. Wright, Hyden & Son Ltd. GB, on behalf of The Institute of Petroleum London, ISBN 0 85501 317 6; Ullmann's Encyclopedia of Ind. Chem., Fifth Completely Revised Edition, Verlag Chemie, DE-Weinheim, VCH-Publishers for U.S., Vol. A 15, page 423 et seq. (Lubricants), Vol. A 13, page 165 et seq. (Hydraulic Fluids).

The lubricants are in particular oils and greases, for example based on mineral oil, synthetic oils, or vegetable and animal oils, fats, tallow and wax or mixtures thereof. Vegetable and animal oils, fats, tallow and wax are, for example, palm kernel oil, palm oil, olive oil, colza oil, rapeseed oil, linseed oil, soy bean oil, cotton wool oil, sunflower oil, coconut oil, maize oil, castor oil, walnut oil and mixtures thereof, fish oils, and chemically modified, e.g. epoxidised or sulphoxidised or alkylated or hydrogenated, forms or forms prepared by genetic engineering, for example soy bean oil prepared by genetic engineering.

Examples of synthetic lubricants include lubricants based on aliphatic or aromatic carboxylic esters, polymeric esters, polyalkylene oxides, phosphoric acid esters, poly-α-olefins or silicones of the diester of a dibasic acid with a monohydric alcohol, e.g. dioctyl sebacate or dinonyl adipate, of a triester of trimethylolpropane with a monobasic acid or with a mixture of such acids, e.g. trimethylolpropane tripelargonate, trimethylolpropane tricaprylate or mixtures thereof, of a tetra ester of pentaerythritol with a monobasic acid or with a mixture of such acids, e.g. pentaerythrityl tetracaprylate, or of a complex ester of monobasic and dibasic acids with polyhydric alcohols, e.g. a complex ester of trimethylolpropane with caprylic and sebacic acid or of a mixture thereof. Particularly suitable in addition to mineral oils are, for example, poly-α-olefins, ester-based lubricants, phosphates, glycols, polyglycols and polyalkylene glycols and mixtures thereof with water.

Said lubricants or mixtures thereof can also be mixed with an organic or inorganic thickener (base fat). Metal working fluids and hydraulic fluids can be prepared on the basis of the same substances as described above for the lubricants. These are frequently also emulsions of such substances in water or other liquids.

Said lubricant compositions, e.g. greases, gear fluids, metal working fluids and hydraulic fluids, may additionally contain further additives which are added in order further to improve their fundamental properties. These include: antioxidants, metal deactivators, rust inhibitors, viscosity index improvers, pour point depressants, dispersants, detergents, tackifiers, thixotropic builders, dewatering agents, antifoam agents, demulsifiers, high pressure additives and antiwear additives. Such additives are added in the amounts customary in each case for the purpose, each in the range from 0.01 to 10.0% by weight. Examples of further additives follow:

### 1. Phenolic Antioxidants

1.1. Alkylated monophenols: 2,6-di-tert-butyl-4-methylphenol, 2-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol , 2,6-dioctadecyl-4-methylphenol, 2,4,6-tricyclohexylphenol, 2,6-di-tert-butyl-4-methoxymethylphenol, linear nonylphenols or nonylphenols which are branched in the side chain, e.g. 2,6-dinonyl-4-methylphenol, 2,4-dimethyl-6-(1′-methyl-undec-1′-yl)-phenol, 2,4-dimethyl-6-(1′-methylheptadec-1′-yl)-phenol, 2,4-dimethyl-6-(1′-methyltridec-1′-yl)-phenol and mixtures thereof
1.2. Alkylthiomethylphenols: 2,4-dioctylthiomethyl-6-tert-butylphenol, 2,4-dioctylthiomethyl-6-methylphenol, 2,4-dioctylthiomethyl-6-ethylphenol, 2,6-didodecylthiomethyl-4-nonyl-phenol
1.3. Hydroquinones and alkylated hydroquinones: 2,6-di-tert-butyl-4-methoxyphenol, 2,5-di-tert-butyl-hydroquinone, 2,5-di-tert-amyl-hydroquinone, 2,6-diphenyl-4-octadecyl-oxyphenol, 2,6-di-tert-butyl-hydroquinone, 2,5-di-tert-butyl-4-hydroxyanisole, 3,5-di-tert-butyl-4-hydroxyanisole, 3,5-di-tert-butyl-4-hydroxyphenylstearate, bis(3,5-di-tert-butyl-4-hydroxyphenyl) adipate
1.4. Tocopherols: α-, β-, γ- or δ-tocopherols and mixtures thereof (vitamin E)
1.5. Hydroxylated thiodiphenyl ethers: 2,2′-thiobis(6-tert-butyl-4-methylphenol), 2,2′-thiobis(4-octylphenol), 4,4′-thiobis(6-tert-butyl-3-methylphenol), 4,4′-thiobis-(6-tert-butyl-2-methylphenol), 4,4′-thiobis(3,6-di-sec-amylphenol), 4,4′-bis(2,6-dimethyl-4-hydroxyphenyl) disulphide
1.6. Alkylidene bisphenols: 2,2′-methylenebis(6-tert-butyl-4-methylphenol), 2,2′-methylenebis(6-tert-butyl-4-ethylphenol), 2,2′-methylenebis(6-tert-butyl-4-ethylphenol), 2,2′-methylenebis[4-methyl-6-(α-methylcyclohexyl)-phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methyl-benzyl)-6-tert-butyl-4-methyl-phenyl] terephthalate, 1,1-bis(3,5-dimethyl-2-hydroxyphenyl)-butane, 2,2-bis(3,5-di-tert-butyl-4-hydroxyphenyl)propane, 2,2-bis(5-tert-butyl-4-hydroxy-2-methylphenyl)-4-n-dodecylmercaptobutane, 1,1,5,5-tetra(5-tert-butyl-4-hydroxy-2-methylphenyl)pentane
1.7. O-, N- and S-benzyl compounds: 3,5,3′,5′-tetra-tert-butyl-4,4′-dihydroxydibenzyl ether, octadecyl 4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl) dithioterephthalate, bis(3,5-di-tert-butyl-4-hydroxybenzyl) sulphide, isooctyl 3,5-di-tert-butyl-4-hydroxybenzylmercaptoacetate
1.8. Hydroxybenzylated malonates: dioctadecyl 2,2-bis(3,5-di-tert-butyl-2-hydroxybenzyl)-malonate, dioctadecyl 2-(3-tert-butyl-4-hydroxy-5-methylbenzyl)malonate, didodecyl mercaptoethyl-2,2-bis(3,5-di-tert-butyl-4-hydroxybenzyl)malonate, di[4-(1,1,3,3-tetramethylbutyl)-phenyl]-2,2-bis(3,5-di-tert-butyl-4-hydroxybenzyl)malonate
1.9. Hydroxybenzyl aromatics: 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol
1.10. Triazine compounds: 2,4-bisoctylmercapto-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl) isocyanurate, 1,3,5-tris(4-tert-butyl-3-hydroxy-2,6-dimethylbenzyl) isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl) isocyanurate
1.11. Acylaminophenols: 4-hydroxylauranilide, 4-hydroxystearanilide, octyl N-(3,5-di-tert-butyl-4-hydroxyphenyl) carbamate
1.12. Esters of beta-(3,5-di-tert-butyl-4-hydroxyphenyl)-propionic acid with monohydric or polyhydric alcohols, e.g. with methanol, ethanol, n-octanol, isooctanol, octadecanol, 1,6-hexanediol, 1,9-nonanediol, ethylene glycol, 1,2-propanediol, neopentylglycol, thiodiethylene glycol, diethylene glycol, triethylene glycol, pentaerythritol, tris(hydroxyethyl) isocyanurate, N,N′-bis(hydroxyethyl)oxalamide, 3-thiaundecanol, 3-thiapentadecanol, trimethylhexanediol, trimethylolpropane, 4-hydroxymethyl-1-phospha-2,6,7-trioxabicyclo[2.2.2]octane
1.13. Esters of beta-(5-tert-butyl-4-hydroxy-3-methylphenyl)propionic acid (with monohydric or polyhydric alcohols), e.g. the alcohols with methanol, ethanol, n-octanol, isooctanol, octadecanol, 1,6-hexanediol, 1,9-nonanediol, ethylene glycol, 1,2-propanediol, neopentylglycol, thiodiethylene glycol, diethylene glycol, triethylene glycol, pentaerythritol, tris(hydroxyethyl) isocyanurate, N,N′-bis(hydroxyethyl)-oxalamide, 3-thiaundecanol, 3-thiapentadecanol, trimethylhexanediol, trimethylolpropane, 4-hydroxymethyl-1-phospha-2,6,7-trioxabicyclo[2.2.2]octane
1.14. Esters of beta-(3,5-dicyclohexyl-4-hydroxyphenyl)propionic acid with monohydric or polyhydric alcohols, e.g. the alcohols stated under 13
1.15. Ester of 3,5-di-tert-butyl-4-hydroxyphenylacetic acid with monohydric or polyhydric alcohols, e.g. the alcohols stated under 13
1.16. Amides of beta-(3,5-di-tert-butyl-4-hydroxyphenyl)propionic acid, e.g. N,N′-bis(3,5-di-tert-butyl-4-hydroxyphenylpropionyl)hexamethylenediamine, N,N′-bis(3,5-di-tert-butyl-4-hydroxyphenylpropionyl)trimethylenediamine, N,N′-bis(3,5-di-tert-butyl-4-hydroxyphenylpropionyl)hydrazine
1.17. Ascorbic acid (Vitamin C)
1.18. Amine antioxidants: N,N′-diisopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methyl-heptyl)-p-phenylenediamine, N,N′-dicyclohexyl-p-phenylenediamine, N,N′-diphenyl-p-phenylenediamine, N,N′-di-(naphth-2-yl)-p-phenylenediamine, N-isopropyl-N′-phenyl-p-phenylenediamine, N-(1,3-dimethyl-butyl)-N′-phenyl-p-phenylenediamine, N-(1-methylheptyl)-N′-phenyl-p-phenylenediamine, N-cyclohexyl-N′-phenyl-p-phenylene-diamine, 4-(p-toluenesulphonamido)diphenylamine, N,N′-dimethyl-N,N′-di-sec-butyl-p-phenylenediamine, diphenylamine, N-allyldiphenylamine, 4-isopropoxy-diphenylamine, N-phenyl-1-naphthylamine, N-(4-tert-octylphenyl)-1-naphthylamine, N-phenyl-2-naphthylamine, octylated diphenylamine, e.g. p,p′-di-tert-octyldiphenylamine, 4-n-butylaminophenol, 4-butyrylaminophenol, 4-nonanoylamino-phenol, 4-dodecanoyla-minophenol, 4-octadecanoylaminophenol, di-(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-di-[(2-methyl-phenyl)-amino]ethane, 1,2-di-(phenylamino)-propane, (o-tolyl)biguanide, di-[4-(1′,3′-dimethyl-butyl)phenyl]amine, tert-octylated N-phenyl-1-naphthylamine, mixture of mono- and dialkylated tert-butyl/tert-octyldiphenylamines, mixture of mono- and dialkylated nonyldiphenylamines, mixture of mono- and dialkylated dodecyldiphenyl-amines, mixture of mono- and dialkylated isopropyl/isohexyldiphenylamines, mixtures of mono- and dialkylated tert-butyldiphenylamines, 2,3-dihydro-3,3-dimethyl-4H-1,4-benzothiazine, phenothiazine, mixture of mono- and dialkylated tert-butyl tert-octyl-phenothiazines, mixture of mono- and dialkylated tert-octylphenothiazines, N-allyl-phenothiazine, N,N,N′,N′-tetraphenyl-1,4-diaminobut-2-ene, N,N-bis-(2,2,6,6-tetramethylpiperidin-4-yl)-hexamethylenediamine, bis-(2,2,6,6-tetramethylpiperidin-4-yl) sebacate, 2,2,6,6-tetramethylpiperidin-4-one, 2,2,6,6-tetramethylpiperidin-4-ol
2. Further antioxidants: aliphatic or aromatic phosphites, esters of thiodipropionic acid or thiodiacetic acid or salts of dithiocarbamic or dithiophosphoric acid, 2,2,12,12-tetra-methyl-5,9-dihydroxy-3,7,11-trithiatridecane and 2,2,15,15-tetramethyl-5,12-dihydroxy-3,7,10,14-tetrathiahexadecane
3. Further metal deactivators:
3.1. Benzotriazoles and derivatives thereof: 2-mercaptobenzotriazole, 2,5-dimercaptobenzotriazole, 4- or 5-alkylbenzotriazoles (e.g. tolutriazole) and derivatives thereof, 4,5,6,7-tetrahydrobenzotriazole, 5,5′-methylenebisbenzotriazole; Mannich bases of benzotriazole or tolutriazole, such as 1-[di(2-ethylhexylaminomethyl)]tolutriazole and 1-[di(2-ethylhexylaminomethyl)]benzotriazole; alkoxyalkylbenzotriazoles, such as 1-(nonyloxymethyl)-benzotriazole, 1-(1-butoxyethyl)benzotriazole and 1-(1-cyclohexyloxybutyl)tolutriazole
3.2. 1,2,4-Triazoles and derivatives thereof: 3-alkyl (or aryl)-1,2,4-triazoles, Mannich bases of 1,2,4-triazoles, such as 1-[di(2-ethylhexyl)aminomethyl]-1,2,4-triazole; alkoxyalkyl-1,2,4-triazoles, such as 1-(1-butoxyethyl)-1,2,4-triazole; acylated 3-amino-1,2,4-triazoles
3.3. Imidazole derivatives: 4,4′-methylenebis(2-undecyl-5-methylimidazole), bis[(N-methyl)imidazol-2-yl]carbinol octyl ether
3.4. Sulphur-containing heterocyclic compounds: 2-mercaptobenzothiazole, 2,5-dimer-capto-1,3,4-thiadiazole, 2,5-dimercaptobenzothiadiazole and derivatives thereof; 3,5-bis[di-(2-ethylhexyl)aminomethyl]-1,3,4-thiadiazolin-2-one
3.5. Amino compounds: salicylidenepropylenediamine, salicylaminoguanidine and salts thereof

### 4. Corrosion Inhibitors:

4.1. Organic acids, their esters, metal salts, amine salts and anhydrides: alkyl- and alkyenylsuccinic acids and partial esters thereof with alcohols, diols or hydroxycarboxylic acids, partial amides of alkyl- and alkenylsuccinic acids, 4-nonylphenoxyacetic acid, alkoxy- and alkoxyethoxycarboxylic acids, such as dodecyloxyacetic acid, dodecyloxy(ethoxy)acetic acid and amine salts thereof, sorbitan monooleate, sodium monooleate, lead naphthenate, alkenylsuccinic anhydrides, e.g. dodecenylsuccinic anhydride, 2-(2-carboxyethyl)-1-dodecyl-3-methylglycerol and salts thereof, in particular sodium salts and triethanolamine salts

### 4.2. Nitrogen-Containing Compounds:

4.2.1 Tertiary aliphatic and cycloaliphatic amines and amine salts of organic and inorganic acids, e.g. oil-soluble alkylammonium carboxylates, and furthermore 1-[N,N-bis-(2-hydroxyethyl)amino]-3-(4-nonylphenoxy)propan-2-ol
4.2.2 Heterocyclic compounds, e.g. substituted imidazolines and oxazolines, e.g. 2-heptadecenyl-1-(2-hydroxyethyl)-imidazoline
5. Sulphur-containing compounds: barium dinonylnaphthalenesulphonates, calcium petroleum sulphonates, alkylthio-substituted aliphatic carboxylic acids, esters of aliphatic 2-sulphocarboxylic acids and salts thereof
6. Viscosity index improvers: polyacrylates, polymethacrylates, vinylpyrrolidone/methacrylate copolymers, polyvinylpyrrolidiones, polybutenes, olefin copolymers, styrene/acrylate copolymers, polyethers
7. Pour point depressants: poly(meth)acrylates, ethylene-vinyl acetate copolymers, alkyl polystyrenes, fumarate copolymers, alkylated naphthalene derivatives
8. Dispersants/Surfactants: polybutenylsuccinamides or polybutenylsuccinimides, polybutenylphosphonic acid derivatives, basic magnesium, calcium and barium sulphonates and phenolates
9. High pressure and antiwear additives: sulphur- and halogen-containing compounds, e.g. chlorinated paraffins, sulphonated olefins or vegetable oils (soy bean oil, rapeseed oil), alkyl or aryl di- or trisulphides, benzotriazoles or derivatives thereof, such as bis (2-ethylhexyl)aminomethyl tolutriazoles, dithiocarbamates, such as methylenebisdibutyl dithiocarbamate, derivatives of 2-mercaptobenzothiazole, such as 1-[N,N-bis(2-ethylhexyl)aminomethyl]-2-mercapto-1H-1,3-benzothiazole, derivatives of 2,5-dimercapto-1,3,4-thiadiazole, such as 2,5-bis(tert.nonyldithio)-1,3,4-thiadiazole
10. Substances for reducing the coefficient of friction: lard oil, oleic acid, tallow, rapeseed oil, sulphurised fats, amines. Further examples are stated in EP-A-0 565 487
11. Special additives for use in water/oil metal processing and hydraulic fluids:
11.1 Emulsifiers: petroleum sulphonates, amines, such as polyoxyethylated fatty amines, non-ionic surface-active substances
11.2 Buffers: alkanolamines
11.3 Biocides: triazines, thiazolinones, trisnitromethane, morpholine, sodium pyridinethiol
11.4 Processing speed improvers: calcium sulphonates and barium sulphonates
11.5 Tackifiers: acrylamide copolymer, polyisubutene resins.
11.6 Thixotropic builders: microcrystalline waxes, oxidized waxes and oxidized esters
11.7 Dewatering agents: polyglycol ethers, butyldiglycols.

Said components can be mixed with the lubricants in a manner known per se. It is also possible to prepare a concentrate or a so-called additive package, which can be diluted to the concentrations of use for the corresponding lubricant according to the application purposes as intended.

A further embodiment of the invention relates to a process for protection against corrosion or oxidative degradation of metals, wherein the metal is exposed to a functional fluid comprising the additive mixture defined above.

A specific embodiment of the invention relates to a process for protection against corrosion or oxidative degradation of zinc, aluminum or alloys thereof, or zinc-coated steels, wherein zinc, aluminum or alloys thereof are exposed to a functional fluid comprising the additive mixture defined above.

The following Examples illustrate the invention:

### 1. Materials and Methods

### 1.1 GENERAL EXAMPLE

25 parts of Sarkosyl O® and 25 parts of napthenic acid are stirred with 15 parts of propylene glycol. The mixture is heated from 30° to 40° C. 14.80 parts of 50% sodium hydroxide solution is added drop wise to the mixture with stirring, until a clear, homogeneous, material is formed. The resulting product is a clear, yellow, viscous liquid containing 60 to 70% of the sodium salt of SARCOSYL O and the sodium salt of Napthenic acid.

### 1.2 Components of Compositions

SARCOSYL O (CIBA product: N-acylsarcosine; N-oleoylsarcosine) and napthenic acid (MERICHEM USA), which is a complex mixture of different low molecular weight fatty acids, is used. These components are neutralized by addition of sodium hydroxide (50% solution) and converted into their sodium salts. Propylene glycol is mixed to the salt mixture to make it flowable at lower temperatures.

| Components | App. Purity | % By Weight |
|---|---|---|
| SARCOSYL O (CIBA) | 90% min. | 31.33 |
| Napthenic acid | 95% min. | 31.33 |
| (1-5% kerosene) | | |
| Propylene glycol (LR) | 99% min. | 18.79 |
| Sodium hydroxide (50% | | 18.55 |
| solution) | | |

### 1.4 Characterizing Data

| Properties | Results |
|---|---|
| Color and Appearance | Clear yellow fluid |
| Density at 20° C. | 1.0571 |
| Kinetic viscosity at 40° C. | 218.8 Cst |
| pH at 25° C. (Neat) | 10.28 |
| Refractive Index at 20° C. | 1.4618 |
| TAN | 5.49 mg KOH/g |
| pH of 1% solution in distilled water | 8.81 |

### 1.4 Preparation of Composition

### 1.4.1 Method 1

Add SARCOSYL O and naphthenic acid to clean kettle equipped with temperature sensors and good agitators fitted with condensors. Mix both the raw materials properly with moderate agitation
Add propylene glycol to the kettle and stir properly until a clear and homogeneous mass is obtained
Maintain the temperature at 30 to 40° C.
Add the alkali solution slowly to the kettle and avoid the formation of agglomerates lumps may not form. The reaction is exothermal, hence the rise of temperature rise should be controlled by controlling the rate of alkali addition or by cooling the system. Temperature of the reaction should be maintained at 60-70° C.
Continue the stirring for about 30 min. after addition of the sodium hydroxide solution
Check the TAN (=Total Acid Number) of the product
Adjust the TAN and pH of the composition to the desired level by adding sodium hydroxide solution or acid mixture (1:1 SARCOSYL O and napthenic acid)

### 1.4.2 Method 2

SARCOSYL O is added to a reaction kettle A equipped with agitator, condenser and temperature sensors. The sodium hydroxide solution is added slowly with continuous stirring. A semi-solid material is formed after complete neutralization. The TAN is checked and should be 5.0+/−1. TAN is adjusted if necessary by addition of SARCOSYL O or sodium hydroxide solution. The temperature is maintained at 60 to 70° C. Propylene glycol is added and the mixture stirred until the composition becomes a clear liquid
Napthenic acid is added to another kettle B and neutralized with sodium hydroxide solution. A semisolid material is formed after complete neutralization. The TAN is checked and should be 5.0+/−1. TAN is adjusted if necessary by either addition of naphthenic acid or sodium hydroxide solution. The temperature is maintained at 60 to 70° C.
Napthenic Acid in kettle B is added to kettle A. The temperature is raised to 50° to 60° C. until the composition becomes a clear viscous liquid
TAN and the pH-value of the composition is determined and recorded.

### 2. COMPARATIVE EXAMPLES

2.1 25 parts of DDBAC (Didecyl dimethyl ammonium bicarbonate) are stirred with 25 parts of water, 25 parts of monoethanolamine and 25 parts of capric acid. The resulting product is a clear, light yellow, homogeneous solution.
2.2 20 parts of C11-dibasic acid (Irgacor® DC11) are stirred with 10 parts of monoethanolamine and 10 parts of triethanolamine. 20 parts of of water are added to the mixture. The resulting product is a clear, pale liquid.
2.3 20 parts of sebacic acid are stirred with 10 parts of monoethanolamine and 10 parts of triethanolamine. 20 parts of of water are added to the mixture. The resulting product is a clear, pale liquid.
2.4 20 parts of a mixture of undecanedioic acid, dodecanedioic acid and C4-C9 dibasic acid (mixture of succinic, glutaric, adipic, pimelic, suberic and azelaic acid) are stirred with 10 parts of monoethanolamine and 10 parts of triethanolamine. 20 parts of of water are added to the mixture. The resulting product is a clear, brown liquid.
2.5 50 parts of tribasic acid (Irgacor®L 190) is stirred with 25 parts of monoethanolamine and 25 parts of triethanolamine. The resulting product is a clear, yellowish liquid.

### 3. Application Tests

### 3.1 Aluminum Corrosion/Staining Test

A 75-40 mm aluminum test strip is cleaned by emery paper (E4 150), immersed in toluene for 30 min. and dried in an oven at 80° C. This cleaned and dried test strip is placed in a 500 ml beaker containing 300 ml of the testing solution. The beaker is covered with Petri dish and placed in an incubator at 65° C. for 3 hrs. The test strip is removed and washed with cold water and allowed to dry at room temperature. The coupon is inspected for signs of corrosion or staining and visually graded as as severe, moderate light or no corrosion/staining. All test solutions are prepared in distilled water. The results are shown in the Table below:

| Test Compositions | %-Concentration | Results |
|---|---|---|
| Product of Example 1 | 1.0 | No corrosion/staining |
| Product of Example 1 | 0.50 | No corrosion/staining |
| Product of Example 1 | 0.20 | No corrosion/staining |
| Product of Example 1 | 0.10 | No corrosion/staining |
| Product of Example 2.1 | 1.00 | Moderate Staining |
| Product of Example 2.2 | 1.00 | Severe Staining |
| Product of Example 2.3 | 1.00 | Severe Staining |
| Product of Example 2.4 | 1.00 | Severe Staining |
| Product of Example 2.5 | 1.00 | Moderate Staining |
| Blank (Control) | | Severe Staining |

1. A composition, which comprises
A) An additive mixture that consists of
a) N-Acylsarcosine of the formula 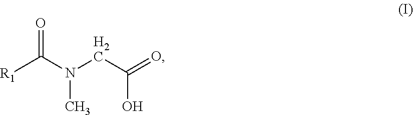
or a salt thereof,
Wherein
R₁ represents C₁-C₂₀alkyl or C₂-C₂₀alkenyl; and
b) A naphthenic acid of the formula 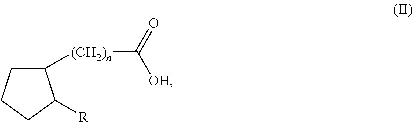
or a salt thereof,
Wherein n represents zero or a numeral from 1 to 10; and
R represents hydrogen or C₁-C₁₀alkyl; and, as optional components,
c) Polyalkylene glycol or propylene glycol; and,
d) Further additives; and
B) A functional fluid.

2. A composition according to claim 1, which comprises
A) An additive mixture that consists of
a) The sodium salt of N-acylsarcosine (I), wherein R₁ represents C₂-C₂₀alkenyl;
b) The sodium salt of a naphthenic acid (II), wherein n represents zero and R represents hydrogen;
c) Propylene glycol; and, optionally,
d) Further additives; and
B) A functional fluid.

3. A composition according to claim 1, which comprises
A) An additive mixture that consists of
a) The sodium salt of N-acylsarcosine (I), wherein R₁ represents oleoyl;
b) The sodium salt of a naphthenic acid (II), wherein n represents zero and R represents hydrogen;
c) Propylene glycol; and, optionally,
d) Further additives; and
B) A functional fluid.

4. A composition according to claim 1, which comprises
A) An additive mixture that essentially consists of
a) The sodium salt of N-acylsarcosine (I), wherein R₁ represents oleoyl;
b) The sodium salt of a naphthenic acid (II), wherein n represents zero and R represents hydrogen;
c) Propylene glycol; and,
d) The sodium salt of oleic acid; and
B) A functional fluid.

5. An additive mixture, which comprises
a) N-Acylsarcosine of the formula 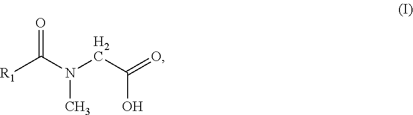
or a salt thereof,
Wherein
R₁ represents C₁₀-C₂₀alkyl or C₁₀-C₂₀alkenyl;
b) A naphthenic acid of the formula 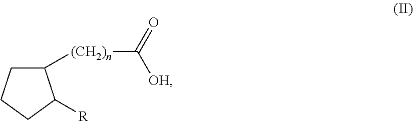
or a salt thereof,
Wherein n represents zero or a numeral from 1 to 10; and
R represents hydrogen or C₁-C₁₀alkyl; and, as optional component,
c) Propylene glycol.

6. An additive mixture according to claim 5, which comprises
a) The sodium salt of N-acylsarcosine (I), wherein R₁ represents oleoyl;
b) The sodium salt of a naphthenic acid (II), wherein n represents zero and R represents hydrogen;
c) Propylene glycol and
d) The sodium salt of oleic acid.

7. A composition according to claim 1, wherein the functional fluid B) is a non-aqueous functional liquid selected from the group consisting of lubricants, hydraulic fluids, metal working fluids, engine coolants, transformer oils and switch gear oils.

8. A process for protection against corrosion or oxidative degradation of metals, wherein the metal is exposed to a functional fluid comprising the additive mixture according to claim 5.

9. A process according to claim 8 for protection against corrosion or oxidative degradation of zinc, aluminum or alloys thereof, or zinc-coated steels, wherein zinc, aluminum or alloys thereof are exposed to the functional fluid comprising the additive mixture.
